(19) United States
(12) Patent Application Publication
(10) Pub. No.: US 2009/0245932 A1
(43) Pub. Date: Oct. 1, 2009

(54) KIND OF OPERATING HANDLE'S LINK SET FOR THE JACK

(75) Inventors: Zhenhua Zhu, Jiangsu (CN); Xueping Zou, Jiangsu (CN); Youyuan Chen, Jiangsu (CN); Xiaofeng Gu, Jiangsu (CN)

Correspondence Address: LADAS & PARRY, 5670 WILSHIRE BOULEVARD, SUITE 2100, LOS ANGELES, CA, 90036-5679, US

(73) Assignee: CHANGSHU TONGRUN AUTO ACCESSORY CO., LTD., Jiangsu (CN)

(21) Appl. No.: 12/363,362

(22) Filed: Jan. 30, 2009

(30) Foreign Application Priority Data
Mar. 28, 2008 (CN) 200810023275.1

(51) Int. Cl. F16B 21/09; B25G 1/00; F16B 21/00

(52) U.S. Cl. 403/327

(57) ABSTRACT

This invention involves a type of connecting device for handle operation, including front node handle, rear node handle and locking pin. The external circle of front node handle (1) vertical to the axis is equipped with two holes of different sizes on the same axis; the external circle (11) of rear node handle is in clearance fit with inner hole (10) of the front node handle, which is provided with a pair of holes of the same axis at the junction of both front and rear node handles for the purpose of realizing the inserted locking of the rear end (7) of the pin to form the moving pair (12) and (13) in clearance fit with the axle and hole; front part (4) of the pin is inserted into the small hole on the external column of front node handle (1) to form the moving pair (8) in clearance fit between hole and axle, which penetrates through the inner hole (5) of the compressed spring to insert the sliding nut (6) into the coordinating hole on the external column of front node handle to form moving pair (9); use the screw pair to screw sliding nut (6) on the front part of the pin to realize combined connection, so as to ensure the reliable operation of handle, and facilitate the storage after use.

### TECHNICAL FIELD

This invention involves a type of connector for jack operating handle, especially a type of connecting device used for serial connection and locking of multi-node handle of the jack.

### BACKGROUND TECHNOLOGY

Most of existing jack operating handle adopts the relatively long single-node handle, which is inconvenient for operation of connected parts even if multi-node composite handles are provided. In particular, operating handle of spiral shear jack is normally fabricated into integrated single-node handle, which is not convenient for the improvement of easy operation by operators and retraction of jack and handle.

### SUMMARY OF THE INVENTION

This invention aims to overcome deficiencies of existing technologies to provide a type of multi-node operating handle of new structure, and therefore convert the conventional single-node long handle into composite handle with more than two nodes, so as to make use of connecting device to fix both front and rear node handles, and ensure the strength of each connected part as well as appropriate action of handle and torsion moment.

Aforesaid purposes of this invention are realized by the following technical proposal: A type of connecting device for operating handle of the jack, including front node handle, rear node handle and locking pin, has the following features: the external circle of front node handle vertical to the axis is equipped with two holes of different sizes on the same axis; the external circle of rear node handle is in clearance fit with inner hole of the front node handle, which is provided with a pair of holes of the same axis at the junction of both front and rear node handles for the purpose of realizing the inserted locking of the rear end of the pin to form the moving pair and in clearance fit with the axle and hole; front part of the pin is inserted into the small hole on the external column of front node handle to form the moving pair in clearance fit between hole and axle, which penetrates through the inner hole of the compressed spring to insert the sliding nut into the coordinating hole on the external column of front node handle to form moving pair; use the screw pair to screw sliding nut on the front part of the pin to realize preliminary tightening for compressed spring.

As compared with existing technologies, this inventions has the following favorable effects: this connecting device can realize the composite connection of multi-node handle to facilitate the flexible extension of operating handle on the site where the jack is used, so as to adapt to different operating distance, and ensure the reliable operation of the handle as well as storage after use.

### ILLUMINATION OF ATTACHED DRAWINGS

Illumination of attached drawings for empirical examples:

FIG. 1: general view of integrated front and rear node handles of this invention

FIG. 2: A-A section of this invention as indicated in FIG. 1, indicating the state when the L-shape pin locks the same axle and hole of front and rear node handles

Locally enlarged figure I of this invention as indicated in FIG. 2

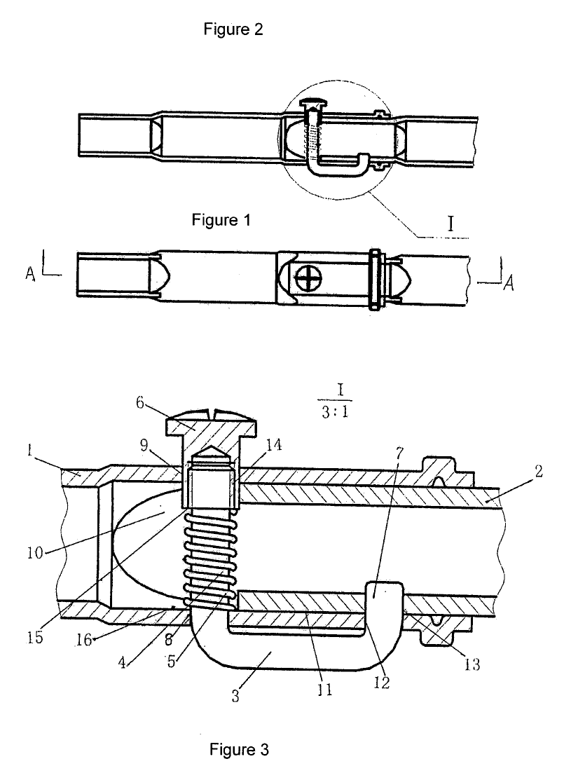

Designations of FIGS. 1, 2 and 3 are stated as follows:

1 front node handle; 2 rear node handle; 3 L-shape pin; 4 front section of the pin; 5 compressed spring; 6 sliding nut; 7 rear section of the pin; 8 moving pair; 9 moving pair; 10 inner holes of both front and rear node handles; 11 external circle of rear node handle; 12 moving pair; 13 moving pair; 14 screw pair; 15 lower end of the screw; 16 hole wall

### Specific Implementation Modes

The following is the further description of this invention in combination with the empirical examples, which is favorable for the understanding of technical contents and effects of this invention.

As indicated in FIGS. 2 and 3, the preset inner hole of front node handle 1 can form a moving revolute pair with the external circle 11 of the rear node handle 2; big and small holes of the same axis are provided on the part of front node handle 1 vertical to the axial line, which form moving pair 9 and 8 respectively with external circle of sliding nut and L-shape pin; inner hole of compressed spring penetrates through the front section 4 of L-shape pin 3; inner screw of sliding nut 6 screw on the external screw of front section 4 of the pin to form screw pair 14; make use of screwing length of screw pair 14 to limit and set the preliminary tightening force of compressed spring 5 in accommodation with the space between the lower end 15 of the nut and hole wall 16 of the front node handle 1; external circle of rear section 7 of L-shape pin 3 forms moving pair 12 and 13 respectively with the same axle and hole of front node handle 1 and rear node handle 2. Connecting device of this invention is operated as follows: manually press the sliding nut 6 to compress the compressed spring 5 to make the whole L-shape pin 3 move downwards to produce displacement; separate the external circle at the rear section 7 of the pin from the coordinating hole of rear node handle to pull the rear node handle 2 away from the front node handle 1 once the moving pair 13 is removed; this is the same for separation of multi-node handle; it is applicable to connect multi-node handles as required in the process of utilization according to the following procedures: press the sliding nut 6 to make the whole L-shape pin 3 move downwards so that upper end of the external circle of pin rear section 7 can be retracted into the coordinating hole of the front node handle 1 thoroughly for the purpose of inserting the external circle 11 of rear node handle 2 into the inner hole 10 of the front node handle; when the front end of the rear node handle 2 moves to the generatrix of the external circle of sliding nut 6, just rotate the rear node handle until it is in superposition with the same axle and hole of the rear node handle; at this point, it is applicable to release the pressure imposed on the upper end of the sliding nut 6; under the elasticity imposed by the compressed spring 5, the rear linkage section 7 of L-shape pin 3 comes into the coordinating hole of the same axis on the rear node handle 2 to form moving pair 12 and 13, so that both front and rear node handles can be connected and locked.

1. A type of connecting device for operating handle of the jack, including front node handle, rear node handle and locking pin, has the following features: the external circle of front node handle (1) vertical to the axis is equipped with two holes of different sizes on the same axis; the external circle (11) of rear node handle is in clearance fit with inner hole (10) of the front node handle, which is provided with a pair of holes of the same axis at the junction of both front and rear node handles for the purpose of realizing the inserted locking of the rear end (7) of the pin to form the moving pair (12) and (13) in clearance fit with the axle and hole; front part (4) of the pin is inserted into the small hole on the external column of front node handle (1) to form the moving pair (8) in clearance fit between hole and axle, which penetrates through the inner hole (5) of the compressed spring to insert the sliding nut (6) into the coordinating hole on the external column of front node handle to form moving pair (9); use the screw pair to screw sliding nut (6) on the front part of the pin to realize preliminary tightening for compressed spring.

2. According to claim 1, the connecting device for operating handle of the jack also has the following features: when the front and rear node handles are connected, the front end of rear node handle (2) will contact with the sliding nut (6).
